(19) United States
(12) Patent Application Publication
(10) Pub. No.: US 2017/0144938 A1
(43) Pub. Date: May 25, 2017

(54) MONOLITH

(71) Applicant: Imperial Innovations Limited, London (GB)

(72) Inventors: Kang Li, Banstead (GB); Zhentao Wu, Sutton (GB)

(73) Assignee: Imperial Innovations Limited, London (GB)

(21) Appl. No.: 15/312,727

(22) PCT Filed: May 14, 2015
(86) PCT No.: PCT/GB2015/051434

§ 371 Date: Nov. 21, 2016

(30) Foreign Application Priority Data
May 20, 2014 (GB) 1408944.5

(51) Int. Cl. C04B 38/00; B01J 35/04; B01J 37/00; B01J 37/08; B01J 35/10; B01J 20/08; B01J 20/28; B01J 20/30; C04B 35/111; C04B 35/628; C04B 35/626; C04B 35/634; C04B 35/638; C04B 35/64; C04B 38/06; B01D 71/02; B01D 67/00; B01D 63/06; B22F 5/10; B28B 3/26; B22F 3/22; B22F 1/00; B01J 21/04

(52) U.S. Cl. CPC C04B 38/0038; B01J 21/04; B01J 35/04; B01J 37/0018; B01J 37/082; B01J 35/1061; B01J 35/1066; B01J 20/08; B01J 20/28042; B01J 20/28083; B01J 20/28085; B01J 20/3042; B01J 20/3007; B01J 20/3078; C04B 35/111; C04B 35/62802; C04B 35/6264; C04B 35/63488; C04B 35/638; C04B 35/64; C04B 38/0635; C04B 38/0615; B01D 71/024; B01D 67/0046; B01D 63/066; B22F 5/10; B28B 3/269; B22F 3/227; B22F 1/0062; C04B 2235/549; C04B 2235/3217; C04B 2235/48; C04B 2235/6021; C04B 2235/656; C04B 2235/6584; C04B 2235/94; B01D 2323/42; B01D 2325/10

(57) ABSTRACT

The present invention relates to a method of making a monolith having a plurality of channels extending therethrough, the method comprising,

providing a suspension of polymer-coated particles in a first solvent;

extruding the suspension from a primary orifice, while passing one or more second solvents from a plurality of secondary orifices arranged within the first orifice, into a third solvent, whereby a monolith precursor is formed from the polymer and particles,

and sintering the monolith precursor to form a monolith.

### REFERENCED TO RELATED APPLICATIONS

This application is a U.S. national stage application of International Patent Application No. PCT/GB2015/051434, filed May 14, 2015, and claims the benefit of priority of Great Britain Application No. 1408944.5, filed May 20, 2014, the entire disclosures of which are incorporated herein by reference.

### FIELD OF THE INVENTION

The present invention relates to a method for forming a monolith, preferably a ceramic monolith, an apparatus for producing the monolith in a single process and to the use of that material for, for example, filtration, especially filtration of water and as a support for catalysts, adsorbents and membranes. In particular, the invention relates to a method for providing a monolith having a plurality of channels therein.

### BACKGROUND OF THE INVENTION

Ceramic membranes are widely used in microfiltration and ultrafiltration. This is due to a number of advantages that they have over polymer counterparts. The advantages include a greater mechanical strength and structural stiffness, greater corrosive and thermal resistance, stable operating characteristics during long service, and the possibility of multiple regenerations by calcination or by the backward stream of water or an appropriate solvent. This means that ceramic membranes can be operated over a wide pH range, at high temperatures and pressures, and in corrosive media. On the other hand, these membranes can be brittle and also expensive due to the energy-intensive technology of their fabrication.

Ceramic membranes are of interest for filtration systems, such as for the filtration of water where the high strength material allows for the use of high pressure filtration. Examples of such filters are discussed in U.S. 2006/0175256.

As discussed in “A morphological study of hollow fiber membranes”, Kingsbury and Li, Journal of Membrane Science 328 (2009) 134-140, it is possible to prepare ceramic hollow fiber membranes by a method of phase inversion. Such membranes have a good porous structure and are ideal for use at high temperatures and pressures, and in corrosive environments. However, the method used provides individual hollow fibers, which lack the necessary resilience for certain applications.

U.S. Pat. No. 5,458,834 discloses a method of forming complex shapes from soft solvent-containing batches and maintaining the integrity of such formed bodies.

U.S. Pat. No. 1,858,620 discloses a hollow brick and tile molding machine.

JPS62101404 discloses an extruder for slurry.

### SUMMARY OF THE INVENTION

Accordingly, it is desirable to provide an improved material and/or tackle at least some of the problems associated with the prior art or, at least, to provide a commercially useful alternative thereto. It is an object of the present invention to provide a monolith in a simple process and having a greater resilience.

In a first aspect the present disclosure provides apparatus for manufacturing a monolith as defined in the claims. In particular, an apparatus for the manufacture of a monolith by extrusion, comprising:

a dye having a primary flow path terminating in a primary orifice;

a plurality of conduits spaced apart and extending into the primary flow path, each conduit terminating in a respective secondary orifice;

means for supplying a material for extrusion along the primary flow path; and

one or more means for supplying a solvent along each conduit.

In a second aspect, the present disclosure provides a method of making a monolith having a plurality of channels extending therethrough, the method comprising,

providing a suspension of polymer-coated particles in a first solvent;

extruding the suspension from a primary orifice, while passing one or more second solvents from a plurality of secondary orifices arranged within the first orifice, into a third solvent, whereby a monolith precursor is formed from the polymer and particles, and

sintering the monolith precursor to form a monolith.

Such a monolith may be suitable for use as a catalyst (if the catalyst is incorporated in the monolith) or a catalyst support (if the catalyst is applied to the surface of the monolith). Particular use of the monolith may be found in the automotive industry.

### BRIEF DESCRIPTION OF THE FIGURES

FIG. 1 shows a cross-sectional SEM image across a monolithic fiber produced as described herein.

FIG. 2A-D shows cross-sectional SEM images of portions of a monolithic fiber.

FIG. 3 shows a graph of the log of the differential intrusion (ml/g) against pore size of an exemplary monolithic fiber.

FIG. 4 shows images of exemplary spinneret designs as discussed herein.

FIG. 5 shows a flow-chart of the key steps in the method.

FIG. 6 shows an exploded perspective view of a dye for use in a spinneret.

FIG. 7 shows a cross-sectional view of the dye of FIG. 6.

FIG. 8 schematically represents an apparatus for extruding a monolith.

### DETAILED DESCRIPTION OF PREFERRED EMBODIMENTS

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The present inventors have found that the provision of a monolith as discussed herein provides a number of distinct advantages. Because the plurality of channels are provided as an integrated single unit, there is an improved mechanical strength and rigidity, compared to a bundle of hollow fibers. Without wishing to be bound by theory, it is considered that the self-assembly of the array of microchannels provides an ideal flow with an enlarged accessible area inside the monolith resulting in a reduced mass transfer resistance inside walls between channels and an improved mass transfer efficiency inside the monolith and the walls between channels. The method allows for flexible use of materials and the overall morphology (length, outer diameter, quantity and size of channels etc.) and micro-structures can be designed and adjusted for specific applications.

Furthermore, the surface area of the monolith can be very high owing to the large number of microchannels distributed over the plurality of channels.

By “monolith” it is meant that the product is comprised of a single continuous material. In contrast, a bundle of hollow fibers held or bound together would not be considered to meet this requirement since they would not be formed as a single piece.

The monolith disclosed herein is described in relation to both metal and ceramic construction materials. it is preferred that the monolith is ceramic, although the method works equally with metallic particles as described herein.

By “ceramic” monolith it is that the structure is formed substantially from any inorganic crystalline or amorphous material compound of a metal and a non-metal. Ceramic materials include, for example, Al₂O₃, SiO₂, ZrO₂, CeO₂, Yttria-stabilized zirconia, cordierite, silicon carbide, clay and TiO₂. It is preferred that the ceramic material comprises a metal oxide.

The present method provides a monolith having a plurality of channels extending therethrough. That is, the monolith is formed with channels running from a first surface to a second surface of the monolith. The basic form provided by the method will be a hollow fiber having the plurality of discrete channels running internally along the length of the fiber.

Due to the method disclosed herein, the monolith may have a “porous” structure. This means that the material of the monolith has a structure comprising a plurality of pores. These pores may, of course, be filled with a further material. Preferably the pores are not filled and form connected porosity within the material to act as flow paths for material being filtered. Examples of such porous materials are well known in the art and the flow paths or channels are ideal for the filtration of a media to be filtered.

In the first step of the method described herein there is provided a suspension of polymer-coated particles in a first solvent. Preferably the particles are ceramic particles and comprise one or more metal oxides, preferably selected from Al₂O₃, ZrO₂, SiO₂, CeO₂, Yttria-stabilized zirconia, cordierite, silicon carbide, clay, TiO₂ and mixtures of two or more thereof. Aluminium oxide and Yttria-stabilized zirconia are especially preferred. The selection of the ceramic particles may be determined by the desired final application of the material. For example, TiO₂ has antibacterial properties, whereas Al₂O₃, and SiO₂ are comparatively cheap and durable, making them suitable for bulk applications.

Alternatively, the particles are metallic particles. Preferably the particles comprise steel, stainless steel (all types, such as, 304 and 316L), FeCr alloys, alloys of iron, aluminium titanate, aluminium, aluminium alloys, copper, copper alloys, nickel, nickel alloys, titanium, titanium alloys, silver, molybdenum, tungsten, zirconium, magnesium, and combinations of two or more thereof.

It is further possible for the particles to comprise a mixture of ceramic and metallic particles as disclosed above. By way of example, the following combinations are preferred embodiments: stainless steel with Al₂O₃ particles, stainless steel with Yttria-stabilized zirconia (YSZ), stainless steel with TiO₂, and stainless steel with SiC.

Preferably the particles have a longest average diameter of from 2 to 0.01 microns. More preferably the particles have a range of sizes within this range. The specific particle size is not especially limiting but can be selected based upon the desired application. By particle it is meant to include a powder or fine granular material.

Preferably the polymer comprises one or more invertible polymers as well as sublimable, especially when the particles used are metals . Such polymers are known in the art. The most preferred polymers for use in the method disclosed herein are Poly(methyl methacrylate) (PMMA), Polyetherimide, Polyethersulfone (PES), PVDF, polysulphone, cellulose and its derivatives, such as cellulose acetate and/or polyimide and its derivatives. In order to select a suitable polymer it is essential that the polymer is soluble in the first solvent and insoluble in the second and third solvents. The polymer may be a mixture of polymers.

Preferably the first solvent comprises one or more of dipolar aprotic solvents, Dimethyl sulfoxide (DMSO), 1-Methyl-2-pyrrolidinone (NMP), N,N-Dimethylformamide (DMF), Acetone, N,N-Dimethylacetamide (DMAc). These solvents are selected due to their ability to form a suspension of the polymer-coated particles and their miscibility with water which allows for the phase inversion technique to form the precursor. The first solvent may be a mixture of solvents.

The suspension is then extruded from a primary orifice, while passing one or more second solvents from a plurality of secondary orifices arranged within the first orifice, into a reservoir of a third solvent, whereby a monolith precursor is formed from the polymer and particles. Preferably the second and/or third solvents comprise water. Water is especially preferred since it is cheap, readily available and non-toxic. The second solvent is selected so that it is miscible with the first solvent and the polymer is insoluble in it. The second and/or third solvents may be a mixture of solvents. The second and/or third solvents are preferably the same.

The monolith precursor is then sintered, optionally under an inert atmosphere, to form a porous monolith. Preferably the monolith precursor is sintered at a temperature of from 1000 to 1800° C., more preferably from 1100 to 1600° C., and most preferably at a temperature of about 1300-1450° C. The use of an inert atmosphere is desirable because it prevents the loss of the polymer/polymer-derived solid deposits during the sintering, thus preventing the formation of an overly densified product. Under an inert atmosphere higher temperatures can be employed because the solid deposits remain and mitigate against over-densification, while the high temperatures result in a stronger final product.

Before sintering, the monolith precursor may be heated in an oxygen-containing atmosphere to at least partially decompose the polymer within the precursor into solid deposits. Preferably the solid deposits comprise carbon deposits and most preferably the deposits consist of carbon deposits. The decomposition of the polymer serves reduce the volume of polymer within the precursor, but also provides thermally resilient solid deposits within the structure. There are various techniques by which this effect can be achieved and these are discussed below.

By an “oxygen-containing atmosphere” it is meant an atmosphere that contains O₂ gas. By a “low-oxygen atmosphere” it is meant an atmosphere that contains less than atmospheric levels of O₂ gas and may even contain no oxygen. The level of oxygen present in the atmosphere can be controlled and monitored, either by using a fixed volume of air or a selected flow-rate. Preferably, where an inert atmosphere is used, this comprises nitrogen. Any inert gas, such as argon or other noble gases can be used. However, nitrogen is particularly cost effective and is preferred. When the particles are or comprise metals, the whole sintering process is preferable conducted under inert atmosphere, and Argon, instead of Nitrogen, is preferred.

Preferably the relative flow rates of the suspension and the second solvents per unit area are substantially the same. This is not essential but can provide a consistent final structure. Nonetheless, the flow rates are highly dependent on the nature of suspension and second solvent, as well as design of the spinneret.

Preferably an outer diameter of the monolith is from 0.1 cm to 50 cm, preferably from 0.3 cm to 40 cm.

Preferably the mean channel diameter is from 0.1 mm to 10 mm, preferably from 0.3 mm to 3 mm.

Preferably the mean channel wall thickness is from 20 microns to 6 mm, and preferably from 100 microns to 4 mm.

Preferably the channels have a plurality of microchannels extending from an inner surface thereof, the microchannels having a width of 5 to 100 microns, preferably from 10 to 60 microns, and a length of up to 5 mm, preferably from 30 microns to 3 mm.

Preferably an outer surface of the monolith and/or a surface of the plurality of channels have a pore size of from 5 nm to 1000 nm, preferably from 10 nm to 500 nm.

Preferably the suspension further comprises one or more catalyst ingredients and/or wherein the method further comprises providing the monolith or the monolith precursor with one or more catalyst ingredients on surfaces thereof. These surfaces may be both the inner surfaces of the hollow tubes and the surfaces of the pores and microchannels.

Preferably one end of the monolith can be capped, whereby a fluid to be treated can be forced from the outer surface into the channels of the monolith. Capping can be achieved by mechanically attaching a cap, or by gluing a cap.

Preferably the monoliths may be used by forming a bundle of said monoliths. This is a similar approach adopted to the use of single hollow fibers, but the strength and surface area available by using the new monolith structure is further improved.

When the method used herein is applied to metal or metal-ceramic mixture powder, the method preferably comprises mixing the powder with a polymer and a suitable solvent to form a uniform suspension. The suspension is then forced to pass a spinneret through its concentric channels to obtain a tubular shape. A liquid is supplied through the central bore of the spinneret to the lumen of the nascent hollow fibre, which is called bore liquid. The nascent hollow fibre is then immersed into a liquid bath, usually water, to go through the so-called phase-inversion process. Here the water bath, often together with the bore liquid, acts as coagulants to the polymer, which can extract the solvent from the suspension and thus precipitate the polymer. The solidified polymer then binds the metal/ceramic powder and fixes the micro-tubular shape. The formed hollow fibre is then transferred to atmosphere-controlled high-temperature furnaces for debinding and sintering, where the organic materials will be removed, and the hollow fibre body gains strength at higher temperatures.

Preferably the method of the second aspect involves the use of the apparatus of the first aspect.

As will be appreciated, the monolith may be produced in any desired shape. However, for the purposes of filtration in particular, it is preferred that the monolith is in the form of a hollow fiber.

The monolith used herein may be provided in the form of hollow tubes or fibers. By providing such fibers with an inlet end and a sealed distal end, a medium may be flowed into the fiber and through the porous structure of the monolith. In this way a filtration is conducted on the medium flowed through the fibers. The medium may desirably be a liquid or a gas. The retentate will generally be particulate matter and the permeate will be a purer liquid or gas. The fibers manufactured according to the present disclosure are typically provided as a cylinder open at each end. Accordingly, desirably one end of the fiber is closed, preferably with a sealant, such as an epoxy resin, to close off the through-flow of the medium to be filtered.

According to a third aspect, there is provided the use of the apparatus discussed herein to make a monolith having a plurality of channels extending therethrough.

According to a fourth aspect there is provided a monolith having a plurality of channels extending therethrough, and having a plurality of microchannels extending from an inner surface of the plurality of channels, the microchannels having a width of 5 to 100 microns. Preferably the microchannels have a length of up to 5 mm. It should be appreciated that the features and embodiments discussed herein with relation to the second embodiment apply equally to the fourth embodiment.

According to a fifth aspect there is provided a monolith obtainable by the method disclosed herein.

According to a sixth aspect there is provided the use of the monolith disclosed herein for filtration, preferably filtration of water, or as a catalytic support. The monolith can also be used in emission control, such as automobile catalysts, due to its high surface area and structural strength. Indeed, for industrial catalyst/adsorbent support, the benefits are an enlarged surface area, better mass transfer, and more efficient use of catalyst. For emissions control the benefits include ideal flow, easy canning, reduced catalyst needed and good stabilities in thermal and mechanical cycling. For filtration the benefits include enlarged separation area, low resistance and high flux.

Other applications of the monolith include as an absorbent, for gas separation, as a porous media for two fluids to contact with each other, or as a membrane support.

For applications relying on filtration, the “separation layer” is the surface of channels and the outer surface of monolith, depending on operation patterns. The thickness of such separation layer may range between a couple of microns to the overall thickness of the walls between monolith channels.

The invention will now be described in relation to the following non-limiting figures, in which:

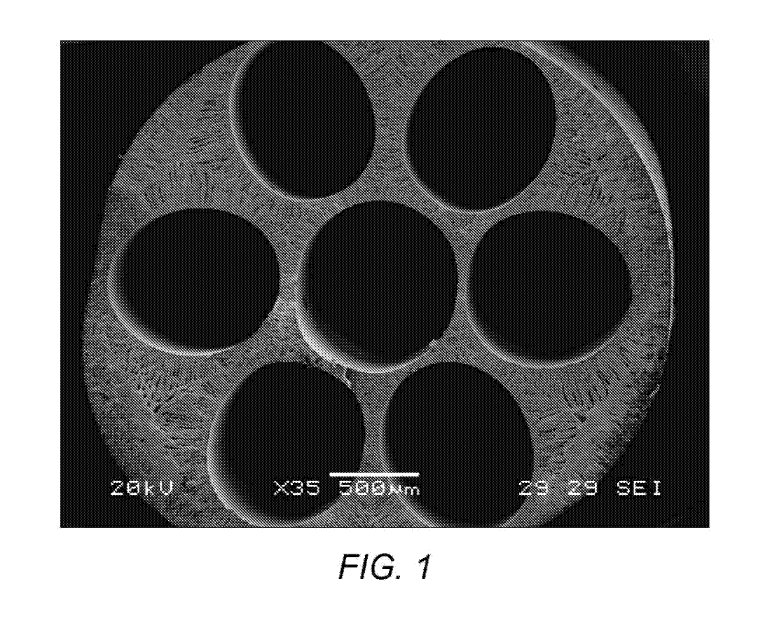

FIG. 1 shows a cross-sectional SEM image across a monolithic fiber produced as described herein. The porous structure can clearly be seen across the width of the tube walls;

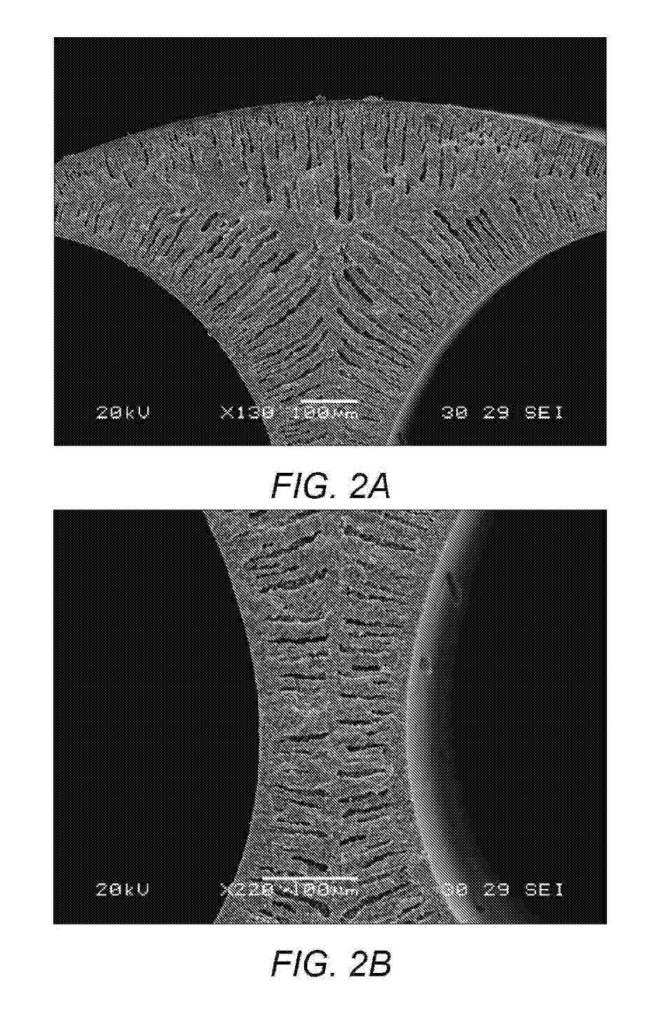

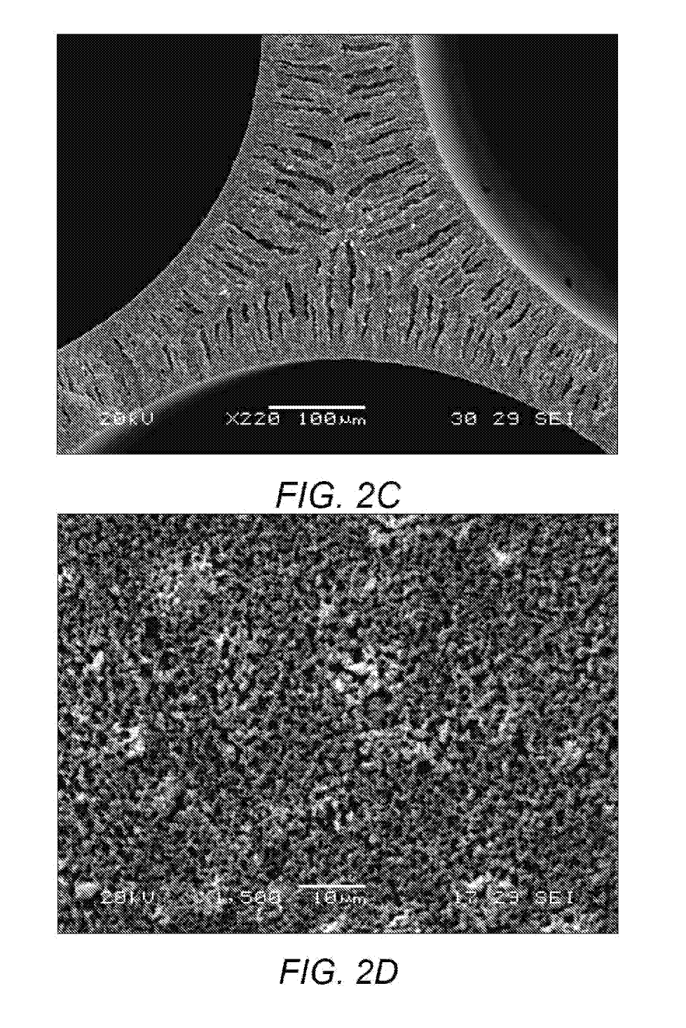

FIG. 2A-D shows cross-sectional SEM images of portions of a monolithic fiber. 2A shows the region between two channels and outer surface. FIG. 2B shows the region between two channels. FIG. 2C shows the region between three channels. FIG. 2D shows an inner surface of a channel;

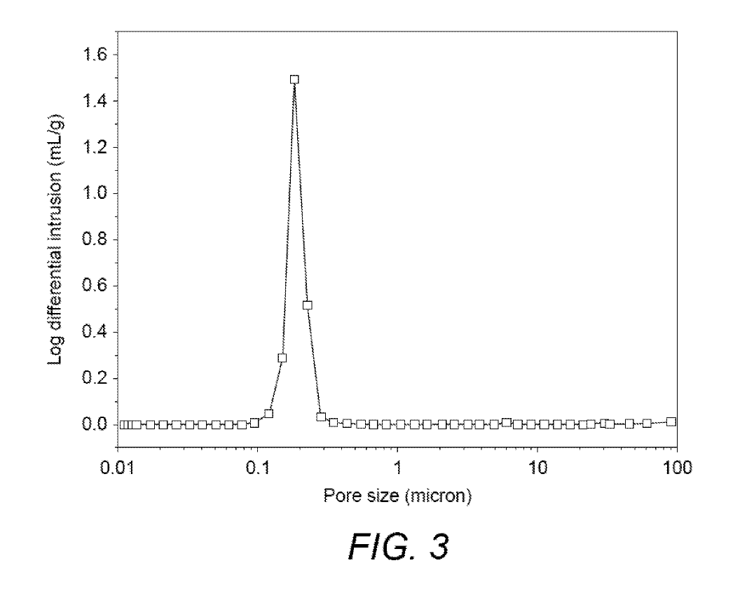

FIG. 3 shows a graph of the log of the differential intrusion (ml/g) against pore size of an exemplary monolithic fiber;

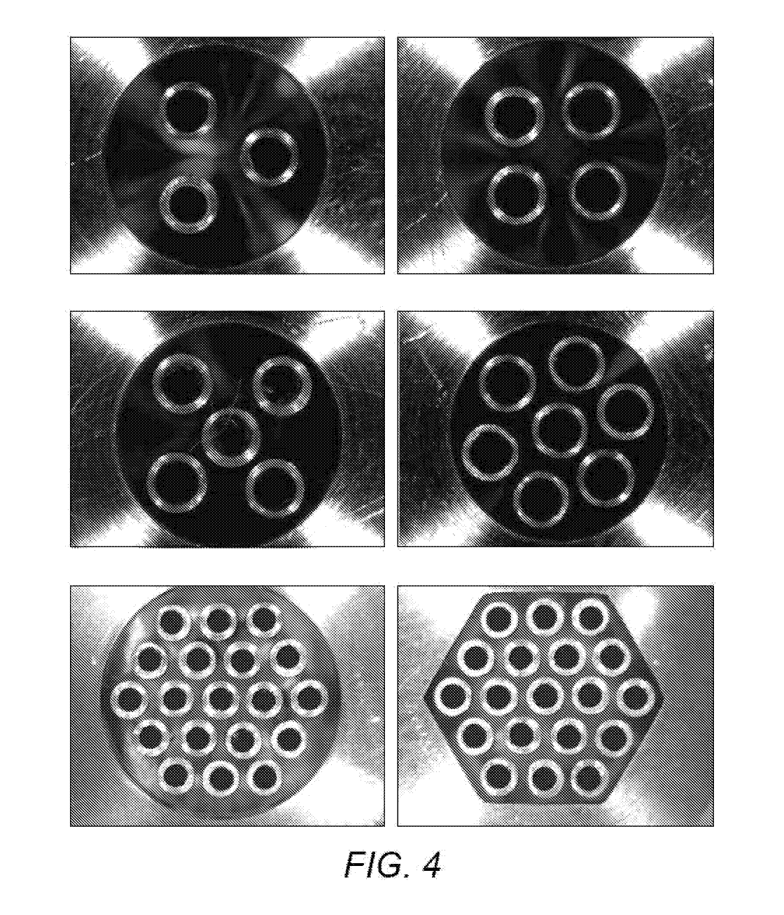

FIG. 4 shows images of exemplary spinneret designs as discussed herein;

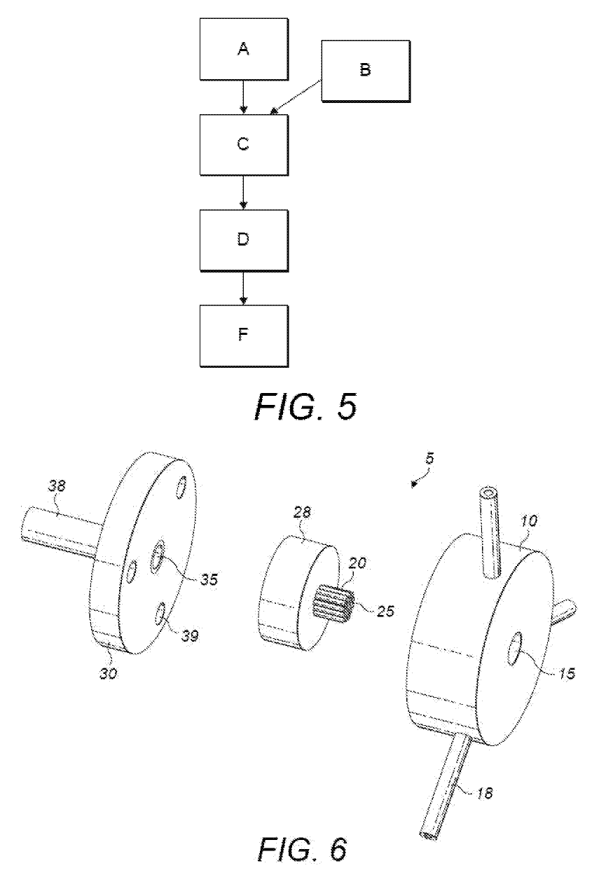

FIG. 5 shows a flow-chart of the key steps in the method;

FIG. 6 shows an exploded perspective view of a dye for use in a spinneret;

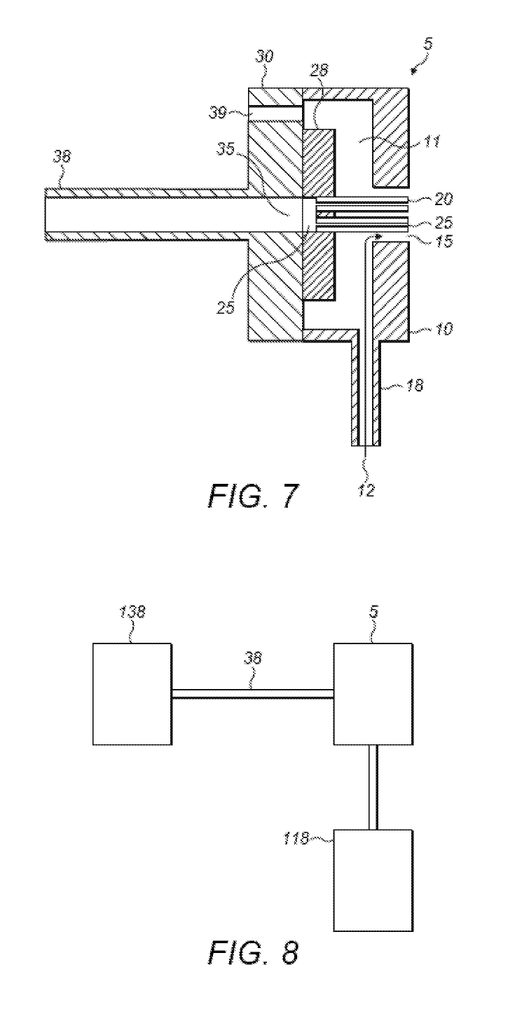

FIG. 7 shows a cross-sectional view of the dye of FIG. 6; and

FIG. 8 schematically represents an apparatus for extruding a monolith.

As shown in FIG. 5, a suspension is provided of polymer-coated particles in a first solvent A. The suspension A is flowed, together with a second solvent B to a spinneret C as described herein. On leaving the spinneret C a monolith precursor D is formed by phase inversion and retained.

The precursor D is then heated to sinter the precursor and form a porous monolith E.

More typically a production process involves the following steps:

1. Ceramic powder or powder mixtures is dispersed in a solvent or mixture of solvents with dispersants dissolved, ball milled for 48 hours

2. Polymer binder or its mixtures is added, with another ball milling of 48 hours

3. the formed suspension is degassed under vacuum, removing air trapped

4. the degassed suspension is transferred into a stainless syringe that controlled by a high pressure syringe pump

5. the suspension is then extruded through a multi-channel spinneret, driven by the high pressure syringe pump with controlled extrusion rate. The distance between the bottom surface of spinneret and external water batch is called as the air gap.

6. water is also extruded with controlled flow rate through the multi-channel spinneret, forming the channels of the precursor fibres

7. the precursor fibres were then cut and dried, prior to being sintered at high temperatures

The invention will now be described in relation to the following non-limiting examples.

### EXAMPLES

In the following examples, a suspension was prepared by mixing the ingredients (except PESf) listed and rolling/milling with 20 mm agate milling balls with an approximate Al₂O₃/agate weight ratio of 2 for 48 h. Milling was continued for a further 48 h after the addition of Polyethersulfone (PESf). The suspension was then transferred to a gas tight reservoir and degassed under vacuum until no bubbles could be seen at the surface. After degassing, the suspension was transferred to a 200 ml Harvard stainless steel syringe and was extruded through a multi-channel spinneret into a coagulation bath containing 120 litres of water (a non-solvent for the polymer) with an air-gap of between 0-15 cm. Deionised water was used as the internal coagulant and the flow rate ranged from 3 to 21 ml/min. The extrusion rate of the spinning suspension and the flow rate of the internal coagulant were accurately controlled and monitored by individual Harvard PHD 22/2000 Hpsi syringe pumps, ensuring the uniformity of the prepared precursor fibres.

The fiber precursors were left in the external coagulation bath overnight to allow for completion of phase inversion. They were then immersed in an excess of DI water which was replaced periodically over a period of 48 h in order to remove traces of the first solvent.

### Example 1

A porous ceramic monolith was prepared as follows. A suspension was prepared using alumina with a mean particle diameter of 1 micron (60 wt %), DMSO (33.6 wt %) as solvent, and PESf as polymeric binder (6 wt %) with Arlacel P135 (polyethylene glycol 30-dipolyhydroxystearate, Uniqema) as a dispersant (0.4 wt %).

This suspension was extruded through a 7 channel spinneret at a rate of 7 ml/min, a water flow rate of 12 ml/min and an air gap of 0.5 cm. This formed a 7 channel monolith which was then sintered at 1350° C. This sample was then tested for fracture loading and the results were as follows:

| | Outer Diameter- | Outer Diameter- | Fracture loading-3 |
|---|---|---|---|
| | precursor (mm) | sintered-1350 (mm) | cm sample (N) |
| Example 1 | 3.7 | 3.22 | 29.72 |

The structure produced was investigated with SEM. It was found that the product was a uniform 7 channel hollow fibre. The structure was self-organised micro-channels throughout the fibre with a sponge-like layer between micro-channel layers. In addition, there was a skin-like sponge-like layer at channel surfaces and outer surface, uniform channel surface and fibre surface. Further investigations showed a uniform pore structure (0.18 micron) by mercury intrusion.

The sample was further tested for water permeation properties. When the outer surface was used solely as the separation layer (outside-in), pure water permeation was 1800 L·m⁻²·h⁻¹·bar⁻¹, which is 38.7 ml/min per cm³ of ceramic monolith. When both the outer surface and some channel surfaces are used as the separation layer (outside-in and inside-out), pure water permeation (at 1 bar) of 51.5 and 54.5 ml/min per cm³ of ceramic monolith can be achieved.

The “walls” between channels were also found to be mechanically stable to quick pressure changes (0-45 psi), as shown in the table below.

| Pressure | |
|---|---|
| cycle | ml/min/cm³ |
| 1 | 156.0 |
| 2 | 158.0 |
| 3 | 157.8 |
| 4 | 158.7 |
| 5 | 157.4 |
| 6 | 157.7 |
| 7 | 157.6 |
| 8 | 157.1 |
| 9 | 157.2 |
| 10 | 156.7 |

### Example 2

A porous ceramic monolith was prepared as follows. A suspension was prepared using alumina of 1 micron mean particle diameter (62 wt %), NMP (31.4 wt %) as solvent, PESf (6.2 wt %) as polymeric binder, dispersant (0.4 wt %).

This suspension was extruded through a 19 channel spinneret at a rate of 11 ml/min, a water flow rate: 18 ml/min and no air gap. This formed a 19 channel monolith which was then sintered at 1350° C. This sample was then tested for fracture loading and the results were as follows:

| | Outer Diameter- | Outer Diameter- | Fracture loading-3 cm |
|---|---|---|---|
| | precursor (mm) | sintered-1350 (mm) | sample (N) |
| Example | 6.62 | 5.68 | 51.60 |
| 2 | | | |

The mercury intrusion plot indicated a slightly more porous channel surface (0.55 micron), through which catalyst or adsorbent can be deposited, with the other peak still at 0.18 micron.

Although preferred embodiments of the invention have been described herein in detail, it will be understood by those skilled in the art that variations may be made thereto without departing from the scope of the invention or of the appended claims.

FIGS. 6, 7, and 8 show a spinneret 5 for the extrusion of the suspension.

The spinneret 5 comprises: a primary orifice 15, which forms a dye to shape the extruded suspension; and a plurality of secondary orifices 25 through which the second solvent(s) may be delivered.

The primary orifice is formed in a first housing portion 10. The first housing portion 10 may be in communication with one or more passages 18 through which the material for extrusion can be provided.

The first housing portion 10 may attached to a second housing portion 30. The first and second housing portions 10 may together provide a cavity 11 which links the first orifice 15 with the passages 18. Fixing holes 39 may be provided in one or both housing portion 10, 30, so that the two housing portions 10, 30 may be attached to one another.

The passages 18, the cavity 11 and the primary orifice 15 define a flow path 12 through which material for extrusion may flow.

Each secondary orifice 25 is defined by the openings at the end of a respective conduit 20. The secondary orifices 25 may lie in a plane.

The conduits 20 pass through the cavity 11. The conduits 20 extend in parallel towards the primary opening 15. The conduits 20 are spaced apart so that extruded material may pass between them. The conduits 20 extend within the flow path 12. Preferably, the conduits 20 extend at least partially through the primary orifice 15. Most preferably, the conduits 20 terminate in line with the primary orifice 15.

The conduits 20 may be in communication with a passage 38 for the supply of second solvent. Passage 38 for the supply of second solvent may terminate in an opening in the housing (preferably the second housing portion 30).

The conduits 20 may be arranged in a regular array with a predetermined spacing therebetween. The array may be a hexagonal array (i.e., such that each conduit 20 has six equally distant nearest neighbours) or a rectangular array (i.e., such that each conduit 20 has four equally distant nearest neighbours).

The conduits 20 may be supported by a support 28. Support 28 may be attached to one or both of the first and second housing portions 10, 30 to locate the conduits 20.

For example, the conduits 20 may extend into respective apertures in a first surface of the support 28. Support 28 may support the conduits 20 such that they communicate with the opening 35 of the passage 38 for the supply of solvent.

The configurations of the primary and secondary orifices 15, 20 may be tailored to the particular application of the monolith.

The primary orifice 15 may have any cross-sectional shape, but is preferably circular, rectangular or hexagonal. When the monolith is used as a membrane for fluid filtration (e.g. water filtration), the primary orifice 15 will preferably have a width from 2 mm to 10 mm. When the monolith is used as a catalyst, the primary orifice 15 may have a width from 2 mm to 20 mm. When the monolith is used as an exhaust gas filter (e.g. an automotive exhaust particulate filter), the primary orifice 15 will preferably have a width from 10 mm to 600 mm. A monolith manufactured using a primary orifice 15 having a width from 500 mm to 600 mm is of particular use as an automotive catalytic convertor.

The secondary orifices 25 may have any cross-sectional shape, but are preferably circular. Preferably, each of the secondary openings 20 will have a maximum width of 0.1 mm to 10 mm. More preferably, each of the secondary openings 20 will have a maximum width of 0.2 mm to 5 mm. Most preferably, each of the secondary openings 20 will have a maximum width of 0.3 mm to 3 mm.

The conduits 20 are preferably spaced apart with a gap in between, wherein the minimum gap between neighbouring conduits 20 is 0.1 mm to 6 mm.

The spinneret 5 is in communication with means for supplying material for extrusion 118, such as a pump or a syringe, etc.

The means for supplying material for extrusion is arranged to provide a flow of material for extrusion along flow path 12.

The spinneret 5 is in communication with one or more means for supplying solvent 138, such as a pump or a syringe, etc.

In some embodiments (such as that illustrated), one means for supplying solvent 138 is provided, and is arranged to provide a flow of solvent along all conduits 20 simultaneously.

In alternative embodiments (not shown), a plurality of means for supplying solvent 138 are provided, and each are arranged to provide a flow of solvent along one or more associated conduits 20.

1. A method of making a monolith having a plurality of channels extending therethrough, the method comprising,
providing a suspension of polymer-coated particles in a first solvent;
extruding the suspension from a primary orifice, while passing one or more second solvents from a plurality of secondary orifices arranged within the first orifice, into a third solvent, whereby a monolith precursor is formed from the polymer and particles,
and sintering the monolith precursor to form a monolith.

2. The method according to claim 1, wherein the sintering of the monolith precursor is performed in an inert or low-oxygen atmosphere and, prior to sintering, there is a step of heating the monolith precursor in an oxygen-containing atmosphere to at least partially decompose the polymer within the precursor into solid deposits.

3. The method according to claim 2, wherein the method further comprises a step of heating the monolith under an oxygen-containing atmosphere to remove the solid deposits.

4. The method according to claim 1, wherein the monolith precursor is sintered at a temperature of from 1000 to 1800° C., more preferably from 1200 to 1600° C., and most preferably at a temperature of about 1300-1450° C.

5. The method according to claim 1, wherein the monolith is a ceramic monolith, and wherein the particles comprise ceramic particles comprising one or more metal oxides selected from Al₂O₃, ZrO₂, SiO₂, CeO₂, Yttria-stabilized zirconia, cordierite, silicon carbide, clay, TiO₂ and mixtures of two or more thereof

6. The method according to claim 1, wherein the monolith is a metallic monolith, and wherein the particles comprise metallic particles comprising steel, stainless steel , FeCr alloys, alloys of iron, aluminium titanate, aluminium, aluminium alloys, copper, copper alloys, nickel, nickel alloys, titanium, titanium alloys, silver, molybdenum, tungsten, zirconium, magnesium, and combinations of two or more thereof.

7. The method according to claim 1, wherein the particles have a longest average diameter of from 2 to 0.01 microns.

8. The method according to claim 1, wherein the polymer comprises one or more invertible polymers selected from the group consisting of Poly(methyl methacrylate) (PMMA), Polyetherimide, Polyethersulfone (PES), PVDF, polysulphone, cellulose and its derivatives, cellulose acetate and/or polyimide and its derivatives.

9. The method according to claim 1, wherein the first solvent comprises one or more of dipolar aprotic solvents, selected from the group consisting of Dimethyl sulfoxide (DMSO), 1-Methyl-2-pyrrolidinone (NMP), N,N-Dimethylformamide (DMF), Acetone, N,N-Dimethylacetamide (DMAc).

10. The method according to claim 1, wherein the second and/or third solvent comprises water, and wherein the second and third solvents are optionally the same.

11. The method according to claim 1, wherein:
(a) an outer diameter of the monolith is from 0.1 cm to 50 cm, preferably from 0.3 cm to 40 cm; and/or
(b) the mean channel diameter is from 0.1 mm to 10 mm, preferably from 0.3 mm to 3 mm; and/or
(c) the mean channel wall thickness is from 20 microns to 6 mm, and preferably from 100 microns to 4 mm; and/or
(d) the channels have a plurality of microchannels extending from an inner surface thereof, the microchannels having a width of 5 to 100 microns, preferably from 10 to 60 microns, and a length of up to 5 mm, preferably from 30 microns to mm; and/or
(e) an outer surface of the monolith and/or a surface of the plurality of channels have a pore size of from 5 nm to 1000 nm, preferably from 10 nm to 500 nm.

12. The method according to claim 1, wherein the suspension further comprises one or more catalyst ingredients and/or wherein the method further comprises providing the monolith or the monolith precursor with one or more catalyst ingredients on surfaces thereof.

13. The method of claim 12, further comprising capping one end of the monolith and/or forming a bundle of said monoliths.

14. The method according to claim 1, wherein the method is performed using an apparatus for the manufacture of a monolith by extrusion, comprising:
a dye having a primary flow path terminating in a primary orifice;
a plurality of conduits spaced apart and extending into the primary flow path, each conduit terminating in a respective secondary orifice;
supplier for supplying a material for extrusion along the primary flow path; and
supplier for supplying a solvent along each conduit.

15. An apparatus for the manufacture of a monolith by extrusion, comprising:
a dye having a primary flow path terminating in a primary orifice;
a plurality of conduits spaced apart and extending into the primary flow path, each conduit terminating in a respective secondary orifice;
means for supplying a material for extrusion along the primary flow path; and
one or more means for supplying a solvent along each conduit.

16. The apparatus of claim 15, wherein the secondary orifices lie in a plane.

17. The apparatus of claim 15, wherein one means for supplying a solvent is in communication with each of the plurality of conduits.

18.-21. (canceled)

22. A monolith having a plurality of channels extending therethrough, and having a plurality of microchannels extending from an inner surface of the plurality of channels, the microchannels having a width of 5 to 100 microns.

23. The monolith of claim 22, wherein the microchannels have a length of up to 5 mm.

24. The monolith of claim 22 obtained by the method of claim 1.

25. (canceled)
